(19) United States
(12) Patent Application Publication
(10) Pub. No.: US 2016/0188585 A1
(43) Pub. Date: Jun. 30, 2016

(54) TECHNOLOGIES FOR SHARED AUGMENTED REALITY PRESENTATIONS

(71) Applicants: Lenitra Durham, Beaverton, OR (US); Deepak Vembar, Portland, OR (US); Cory Booth, Beaverton, OR (US); Glen Anderson, Beaverton, OR (US); Giuseppe Raffa, Portland, OR (US); Lisa Kleinman, Portland, OR (US); Michael Crocker, Portland, OR (US); Kathy Yuen, Portland, OR (US)

(72) Inventors: Lenitra Durham, Beaverton, OR (US); Deepak Vembar, Portland, OR (US); Cory Booth, Beaverton, OR (US); Glen Anderson, Beaverton, OR (US); Giuseppe Raffa, Portland, OR (US); Lisa Kleinman, Portland, OR (US); Michael Crocker, Portland, OR (US); Kathy Yuen, Portland, OR (US)

(21) Appl. No.: 14/583,659

(22) Filed: Dec. 27, 2014

(51) Int. Cl. G06F 17/30; H04N 13/04; G02B 27/01; G06T 19/00

(52) U.S. Cl. CPC G06F 17/3028; G06T 19/006; H04N 13/0447; G02B 27/0172; G02B 2027/0178

(57) ABSTRACT

A system and a method for providing a shared augmented reality presentation are disclosed. A group presentation server communicates with one or more wearable computing devices. The group presentation server coordinates the outputs of the various wearable computing devices to present a shared augmented reality presentation to members of group, where every member of the group experiences a unique perspective on the presentation.

### BACKGROUND

Typical augmented reality systems project virtual characters and objects into physical locations, allowing for immersive experiences and novel interaction models. Augmented reality presentations supplement a real-world environment with computer-generated sensory stimulus, such as sound or visual data. Augmented reality offers users a direct view of the physical world, while augmenting the real-world view with computer-generated sensory inputs such as sound, video, graphics, or GPS data. Augmented reality systems frequently use head-worn computing devices to output the computer generated sensory inputs. Oftentimes, an augmented reality presentation can be a solo experience, with each person viewing a separate instantiation of the augmented reality presentation. In certain environments, such as guided tours or group events, a group presentation may be more beneficial or desirable than individual, solo presentations.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a shared augmented reality presentation system for generating a shared augmented reality presentation;

FIG. 2 is a simplified block diagram of at least one embodiment of a shared presentation server of the system of FIG. 1;

FIG. 3 is a simplified block diagram of at least one embodiment of a wearable computing device of the system of FIG. 1;

FIG. 4 is a simplified block diagram of at least one embodiment of an environment that may be established by the shared presentation server of FIG. 2;

FIG. 5 is a simplified block diagram of at least one embodiment of an environment that may be established by the wearable computing device of FIG. 3;

FIGS. 6A-6B is a simplified flow diagram of at least one embodiment of a method for generating a shared augmented reality experience that may be executed by the shared presentation server of FIG. 2; and

FIG. 7 is a simplified flow diagram of at least one embodiment of a method for outputting a shared augmented reality experience that may be executed by the wearable computing device of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

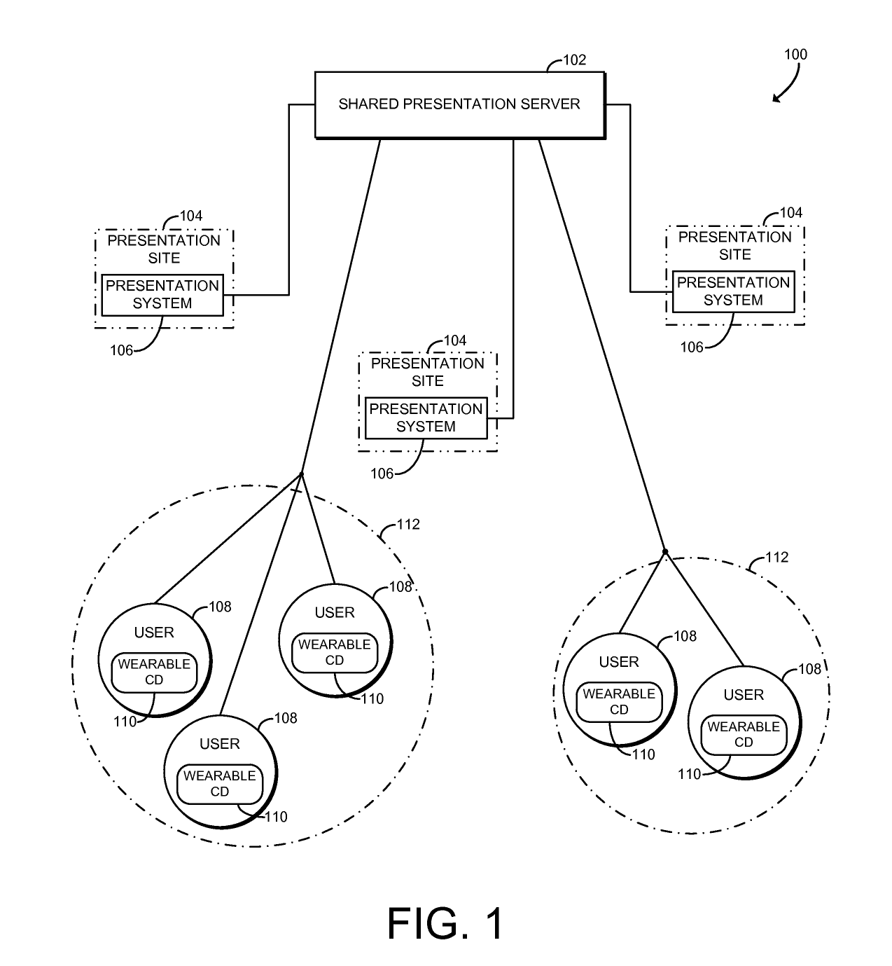

Referring now to FIG. 1, an illustrative system 100 for presenting a shared augmented reality presentation is shown. The system 100 includes a shared presentation server 102 connected to a number of presentation systems, each located at an associated presentation site 104. While the illustrative embodiment includes three presentation sites, it should be appreciated that any number of presentation sites can be connected to the shared presentation server 102. Users 108 are also connected to the shared presentation server 102 through one or more wearable computing devices 110. One or more users 108 are organized into a group 112, and each individual group 112 can include any number of users 108. As discussed in more detail below, the shared presentation server 102 links the individual users 108 into a group 112, and then presents a shared augmented reality presentation to the users 108 in the group 112 through the presentation systems 106 and the wearable computing devices 110.

In current augmented reality systems, correlation of experience between members of the same group can be nonexistent. Conversely, as described in more detail below, the shared presentation server 102 is configured to coordinate the sensors and actuators of presentation systems 106, and the sensors and actuators of the wearable computing devices 110, to provide a shared group experience to one or more users 108 of the group 112. The augmented reality experience presented by the system 100 targets only members of the group 112. As the members 108 of the group 112 move though one or more presentation sites 104, their augmented reality presentations are synchronized so that every user 108 sees and hears the same augmented reality elements, albeit from different perspectives. For example, if a group 112 were at a presentation site 104 that represents King Tut and ancient Egypt, a synchronized group augmented reality presentation could include the users 108 seeing King Tut walking around, as if he were present at the presentation site 104; however, each user 108 would see King Tut from a different perspective, depending on the location of the user 108. Additionally, another group 122 of users 108 present at the same presentation site 104 may see a different version of King Tut, a different interaction from King Tut, a different temporal point of the presentation, and/or the like.

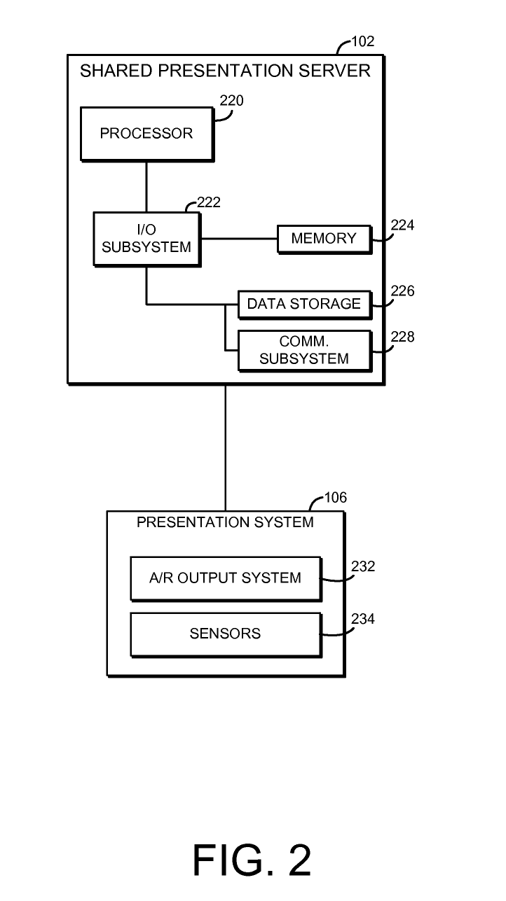

An illustrative embodiment of the shared presentation server 102 is shown in FIG. 2. The shared presentation server 102 for presenting a shared augmented reality presentation to a group of users includes a processor 220, an I/O subsystem 222, a memory 224, and a data storage device 226. The server 102 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. As shown in FIG. 2, the server 102 illustratively includes the processor 220, the input/output subsystem 222, the memory 224, and the data storage device 226. Of course, the server 102 may include other or additional components, such as those commonly found in a server device (e.g., various input/output devices), in other embodiments. Additionally, in some embodiments, one or more of the illustrative components may be incorporated in, or otherwise form a portion of, another component. For example, the memory 224, or portions thereof, may be incorporated in the processor 220 in some embodiments.

The processor 220 may be embodied as any type of processor capable of performing the functions described herein. For example, the processor 220 may be embodied as a single or multi-core processor(s), digital signal processor, microcontroller, or other processor or processing/controlling circuit. Similarly, the memory 224 may be embodied as any type of volatile or non-volatile memory or data storage capable of performing the functions described herein. In operation, the memory 224 may store various data and software used during operation of the server 102 such operating systems, applications, programs, libraries, and drivers. The memory 224 is communicatively coupled to the processor 220 via the I/O subsystem 222, which may be embodied as circuitry and/or components to facilitate input/output operations with the processor 220, the memory 224, and other components of the server 102. For example, the I/O subsystem 222 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 222 may form a portion of a system-on-a-chip (SoC) and be incorporated, along with the processor 220, the memory 224, and other components of the server 102, on a single integrated circuit chip.

The data storage device 226 may be embodied as any type of device or devices configured for short-term or long-term storage of data such as, for example, memory devices and circuits, memory cards, hard disk drives, solid-state drives, or other data storage devices. The data storage device 226 may store compressed and/or decompressed data processed by the server 102.

The server 102 may also include a communication subsystem 228, which may be embodied as any communication circuit, device, or collection thereof, capable of enabling communications between the server 102 and other remote devices over a computer network (not shown). The communication subsystem 228 may be configured to use any one or more communication technology (e.g., wired or wireless communications) and associated protocols (e.g., Ethernet, Bluetooth®, Wi-Fi®, WiMAX, etc.) to effect such communication. The server computing device can include other peripheral devices as might be necessary to perform the functions of the server, such as displays, keyboards, other input/output devices, and other peripheral devices.

The shared presentation server 102 is connected to one or more presentation systems 106 located at one or more presentation sites 104. The presentation systems 106 may be embodied as any type of computation or computer device capable of performing the functions described herein, including, without limitation, a computer, a multiprocessor system, a server, a rack-mounted server, a blade server, a laptop computer, a notebook computer, a network appliance, a web appliance, a distributed computing system, a processor-based system, and/or a consumer electronic device. The presentation systems 106 include many of the same components and systems as the server 102 described above, and those descriptions are not repeated here; however, it will be appreciated that the presentation systems 106 are embodied similarly to server 102. The presentation systems 106 further include augmented reality output systems 232 and sensors 234. The augmented reality output systems 232 include a collection of output devices used to present a shared augmented reality presentation at a presentation site 104 to a group 112 of users 108. In some embodiments, the augmented reality output systems 232 include a touchscreen graphical user interface, a video display, one or more speakers, a projector, a laser display, a physical display of some type, or some other output means. The sensors 234 are configured to detect the presence of users at a particular presentation site and to detect the reaction of the users to the augmented reality presentation being presented. In some embodiments, sensors 234 include cameras, motion sensors, heat sensors, microphones, and other sensing devices.

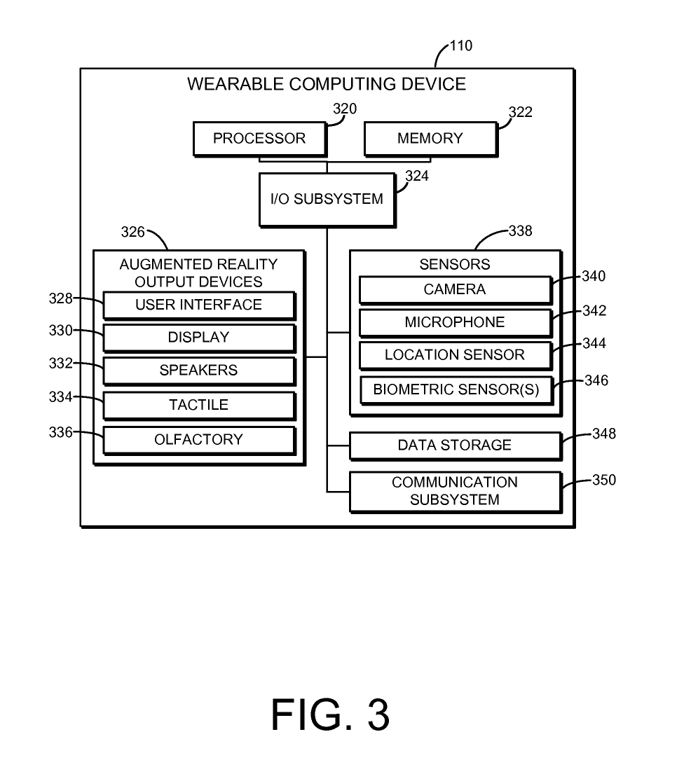

An illustrative embodiment of the wearable computing device 110 is shown in FIG. 3. The wearable computing device 110 is capable of outputting a shared augmented reality presentation to a user 108 in a group 112 and illustratively includes a processor 320, a memory 322, an I/O subsystem 324, a data storage device 348, and a communication subsystem 350. The computing device 110 may be embodied as any type of wearable computation or computer device capable of performing the functions described herein, including, without limitation, a head-mounted computer system, smart glasses, virtual reality glasses or headgear, smart ocular or cochlear implant, smart phone, smart watch, smart clothing, a computer, a mobile computing device, a tablet computer, a notebook computer, a laptop computer, a smart appliance or tool, and/or other wearable or mobile computing devices. In general, components of the computing device 110 having the same or similar names to components of the server 102 described above and may be embodied similarly. As such, a discussion of those similar components is not repeated here.

The illustrative embodiments of the wearable computing device 110 also includes a number of augmented reality output devices 326 configured to present a shared augmented reality presentation to the user 108 of the wearable computing device 110. The augmented reality output devices 326 may include a user interface 328, a display 330, speakers 332, a tactile output 334, and an olfactory output 336. The purpose of the augmented reality output devices 326 is to provide an immersive augmented reality experience to the user 108 of the wearable computing device 110. In some embodiments, the user interface 328 can include a graphical touchscreen that allows the user make varies selections from augmented reality options and control the user's augmented reality experience. The display 330 can include any type of display, but in some embodiments, it includes a head mounted display or another type of wearable display, such as Google Glass™. The speakers 332 provide auditory outputs to the user 108, and can include algorithms to adjust the sound to provide a more immersive experience. For example, the speakers 332 can be configured such that a user 108 of the wearable computing device 110 will perceive that the sound is coming from a particular direction. If the speakers can cause the user 108 to perceive the sound coming from a particular direction or location, then the wearable computing device 110, in conjunction with the shared presentation server 102, can create a more immersive augmented reality experience. The wearable computing device 110 can also include any tactile 334 or olfactory 336 outputs as is necessary for the augmented reality experience. For example, the wearable computing device 110 could include artificial scent distributors to cause the user 108 to experience a particular scent at a particular time during the augmented reality presentation.

The wearable computing device 110 also includes sensors 338 configured to capture the context data regarding what the user 108 of the wearable computing device 110 perceives and the user's reactions to such stimuli (e.g., the user's emotions or state of being). In some embodiments, one or more cameras 340 can be coupled to the wearable computing device 110 to capture what the user 108 perceives during the shared augmented reality experience. One or more cameras 340 can also be coupled to the wearable computing device to monitor the user 108. For example, a camera 340 can be used as a gaze detector to determine where the user 108 is looking during the augmented reality presentation. In another example, the one or more cameras 340 can capture the facial expressions of the user 108 as he or she experiences the augmented reality presentation. Capturing the facial expressions of the user 108 enables the augmented reality system 100 to determine the user's 108 reactions to the shared augmented reality presentation. A microphone 342 can also be included in the wearable computing device 110 to capture sounds made by the user 108, for example, voice commands or exclamatory sounds reacting to the shared augmented reality experience. Input devices of the wearable computing device can include a touchpad or buttons, a compatible computing device (e.g., a smartphone or control unit), speech recognition, gesture recognition, eye tracking, or a brain-computer interface.

The wearable computing device 110 illustratively includes a location sensor 344 to determine the location of the wearable computing device 110. In some embodiments, the presentation of a shared augmented reality experience is tied to one or more presentation sites 104. The shared presentation server 102 uses the location data, measured by the location sensor 344, to determine when an augmented reality presentation should be initiated or terminated for a user. In effect, in some embodiments, the shared presentation server 102 uses the data from the location sensor 344 to automatically determine if a presentation request has been received by the shared presentation server 102. Biometric sensor(s) 346 can also be coupled to the wearable computing device 110, and be configured to measure a number of different physiological and cognitive responses of the user 108 to the shared augmented reality experience. For example, the wearable computing device 110 can include a heart rate monitor to measure the user's 108 heart rate. In other embodiments, the biometric sensor(s) 346 can include an accelerometer to measure motion of the user 108 (e.g., a breathing monitor), a monitor to measure brain activity, or a monitor to measure the temperature of the user 108. The biometric sensor(s) 346 can be used to collect context data about the user 108, e.g., laughter, or a high heart rate, and then the shared presentation server 102 can use that data to adjust the shared augmented reality presentation, or to recommend other augmented reality presentations. Biometric sensor(s) 346 can be used to assess the group's 112 reaction to the augmented reality presentation, and adjust the presentation in real-time if boredom is detected, e.g., conversation between members of the group 112 or yawning of the users 108.

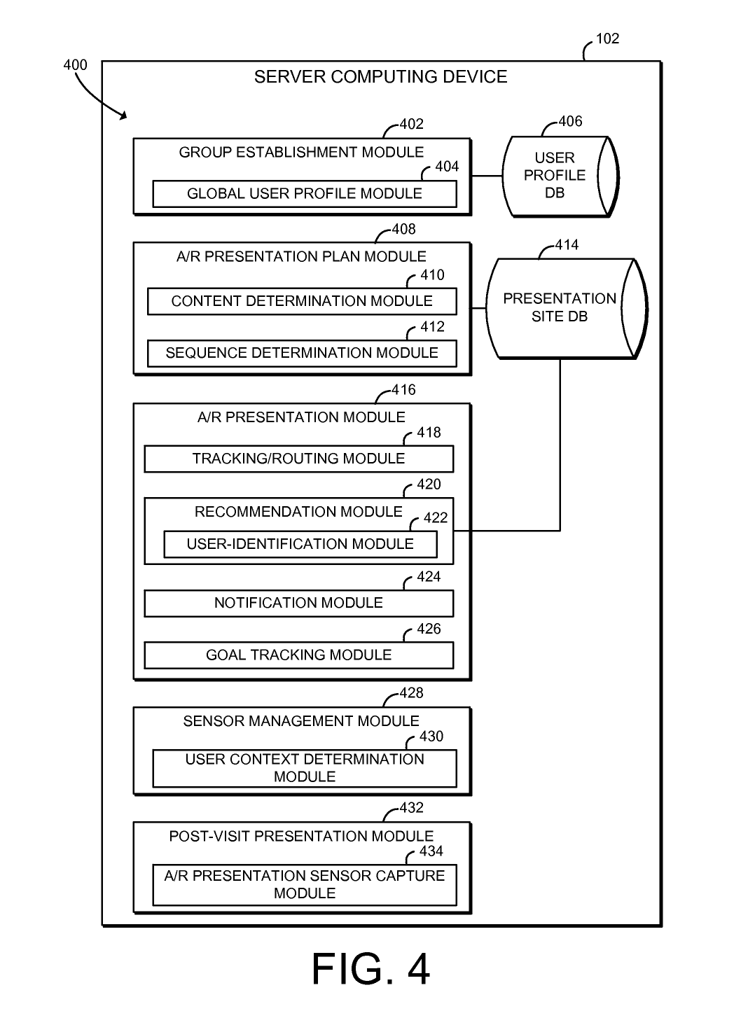

Referring now to FIG. 4, in the illustrative embodiment, the shared presentation server 102 establishes an environment 400 during operation. The illustrative embodiment 400 includes a group establishment module 402, an augmented reality presentation plan module 408, an augmented reality presentation module 416, a sensor management module 428, and a post-visit presentation module 432. In use, the server 102 is configured to generate a shared augmented reality presentation, determine individual presentation data for each individual wearable computing device 110 and each presentation system 106, and present the shared augmented reality experience through each of the wearable computing devices 110 and the presentation systems 106. The various modules of the environment 400 may be embodied as hardware, firmware, software, or a combination thereof. For example the various modules, logic, and other components of the environment 400 may form a portion of, or otherwise be established by, the processor 220 or other hardware components of the server 102.

The group establishment module 402 is configured to establish one or more wearable computing devices 110 into a group network to provide a shared augmented reality presentation to a group of people visiting the location in question. In the illustrative embodiment the shared presentation server 102 is dedicated to a particular location, such as, for example, a museum or zoo. For instance, when taking students on a field trip to a museum, the teacher may have specific exhibits that the teacher wants the class to experience, while other groups visiting the museum may have different goals. The group establishment module 402 links a subset of the total wearable computing devices 110 present at the location (e.g., the museum) into a group network. The group network corresponds to a group 112 of users 108 who wish to have shared experiences at the presentation sites 104.

As such, the group establishment module 402 includes a global user profile module 404. The global user profile module 404 is configured to receive group profiles and individual profiles to establish an augmented presentation plan for the group 112. In some embodiments, users 108 in the group 112 enter information about various preferences the individual user 108 may have. In other embodiments, the user 108 can choose from a pool of pre-determined profiles that the user 108 would like to experience. The user profiles are stored on a user profile database 406, which is accessed by the group establishment module 402. As the group establishment module 402 establishes the group network of wearable computing devices 110, the group profile and individual user profiles are loaded onto the wearable computing devices 110 in the group network. The group establishment module 402 also links the wearable computing devices 110 in the group network, such that individual wearable computing devices 110 in the group network can communicate directly with one another. After organizing the wearable computing devices 110 of the group 112 into a group network, the shared presentation server 102 can target shared augmented reality presentation to the group 112, such that just the group 112 experiences the targeted shared augmented reality presentation. For example, creating the group network allows the shared presentation server 102 to produce three-dimensional augmented reality that can only be experienced by members of the group 112. In some embodiments, the shared presentation server 102 uses the location of each user 108 of the group 112 to calculate individual presentation data to be output to each wearable computing device 110 in the group network. For example, the location of the wearable computing device 110 may be derived by analyzing multiple data points, such as signal strength, microphone inputs, or orientation based measurements made using an accelerometer or gyroscope associated with the sensors 338. The individual presentation data allows each wearable computing device 110 in the group network to display a unique perspective of the shared augmented reality presentation. In use, when a class goes on a field trip to a museum, the teacher may have a list of places that the teacher wants the students to visit, or areas that the students should avoid. This information can be entered into the system 100 when the group 112 arrives at the location. In other embodiments the teacher's preferences can entered before the class reaches the location. For example, the teacher and the students of the class can setup user profiles online, before coming to the museum. As part of entering the user profiles, the teacher and the students can experience a virtual reality preview, which will allow different options to be selected and stored in the user profiles.

The augmented reality presentation plan module 408 is configured to generate a presentation plan based on the one or more user profiles in the user profile database 406 associated with the particular group 112. The augmented reality presentation plan module 408 includes a content determination module 410 and a sequence determination module 412. The content determination module 410 analyzes the user profile of the group and the user profiles of the individual group members, and determines what presentation sites 104 should be part of the group presentation plan. When making the presentation plan the augmented reality presentation plan module 408 accesses a pool of available augmented reality presentations in a presentation site database 414, which includes information about all of the different augmented reality presentations available at all of the presentation sites 104 associated with the shared presentation server 102. In some embodiments, this is done by assigning a confidence score to each available augmented reality presentation in the database 414, based on the user profile data. Both the user profile database 406 and the presentation site database 414 can be embodied as part of the shared presentation server 102, or both databases 406, 414 can be external to the server 102 and connected to the server 102 through one or more computer networks.

The sequence determination module 412 determines the sequence of shared augmented reality presentations for the group 112. The sequence of the augmented reality presentations could be based on specific preferences of the group, e.g., a teacher wants to teach particular lessons in a particular order, or it could be based on the most efficient way to travel between presentation sites 104, e.g., minimizing the walking distance between museum exhibits. In some embodiments, the augmented presentation plan module is capable of adjusting the presentation plan in response to the group 112 deviating from the originally produced presentation plan. Information, such as location data and context data measuring the user's reactions to the shared augmented reality presentations, can be used to adjust the presentation plan to best fit the needs of the group 112.

The augmented reality presentation module 416 is configured to provide a shared group augmented reality presentation through each of the wearable computing device 110 in the group network and the presentation systems 106 associated with the presentation sites 104. The augmented reality presentation module 416 receives the group presentation plan and receives one or more presentation requests to determine if the presentation module 416 should present a particular augmented reality presentation to the group. For example, in some embodiments, a presentation request is sent to the shared presentation server 102 to begin a particular augmented reality presentation after the group 112 arrives at a presentation site 104 included in the presentation plan. In other embodiments, a presentation request can include the user inputting some indication to begin the augmented reality presentation, such as, for example, the user pressing the augmented reality presentation button present at a presentation site 104.

The augmented reality presentation module 416 generates a shared augmented reality presentation to be presented to the group 112. The augmented reality presentation module 416 uses the overall group augmented reality presentation to develop individual presentation data to be displayed by individual wearable computing devices 110 of the group network. For example, the group augmented reality presentation could dictate that a King Tut augmented reality element should be perceived by the users 108, at a particular spot at the presentation site 104. The augmented reality presentation module 416 receives the location of each wearable computing device 110, generates individual presentation data for each wearable computing device 110, and that individual presentation data allows the wearable computing device 110 to present the King Tut from its unique perspective. In some embodiments, the augmented reality presentation module 416 can make it seem that other users 108 in the group 112 are wearing different clothes, usually related to the shared augmented reality presentation being presented, for example, a user 108 could see other members of the group 112 dressed as ancient Egyptians while the group is at the ancient Egypt presentation site 104.

The augmented reality presentation module 416 includes a tracking/routing module 418, a recommendation module 420, a notification module 424, and a goal tracking module 426. The tracking/routing module 418 is configured to track the location of each wearable computing device 110 in the group network. The location of each wearable computing device can be critical to an immersive augmented reality experience. For example, a shared group reality experience about ancient Egypt will only make sense if the user 108 is located at the presentation site 104 associated with ancient Egypt. Furthermore, in some embodiments, the augmented reality experience includes the users 108 of the group 112 experiencing the same augmented reality element, but from different perspectives. For example, members of the group 112 might be viewing an exhibit about King Tut, an element of the augmented reality presentation might include presenting King Tut as he may have appeared when he was alive. The locations of individual wearable computing devices 110 can be used to determine different viewing perspectives of the King Tut augmented reality element for each individual wearable computing device 110 in the group network. The tracking/routing module 418 is also configured to manage traffic flow at the location associated with the shared presentation server 102. For example, certain presentation sites 104 might be more popular with users 108 than other presentation sites 104, and, consequently, the crowds can diminish the shared augmented reality presentation experienced by the users 108. The tracking/routing module 418 can provide suggestions, through the recommendation module 420, to ensure that certain presentation sites 104 do not become overcrowded. Furthermore, in some embodiments, the tracking/routing module 418 can send notifications, through the notification module 424, to at least one of the wearable computing devices 110 of the group network that identifies the location of at least one other wearable computing device 110 in the group network. For example, the wearable computing device 110 of a supervisor member of the group 112, such as a teacher or a tour guide, could be configured to display the location of every other wearable computing device 110 in the group network.

The recommendation module 420 is configured to provide recommendations to the group 112 about which shared augmented reality presentations to experience based on the user profiles, the location of the group 112 and the presentation sites 104, and traffic flowing through the location. The recommendation module 420 includes a user-identification module 422 configured to provide recommendations to a group 112 based on other users 108, not in the group 112, present at the location. For example, if the group 112 is visiting a World War II presentation site, the user-identification module 422 can alert the group 112 if a World War II veteran is present at the same location. In some embodiments, the user-identification module 422 uses user profile data to determine if a specific user 108 is a person of interest related to one or more augmented reality presentations at the location.

The notification module 424 is configured to present the user 108 of the wearable computing device 110 notifications about various happenings at the location associated with the shared presentation server 102. For example, a notification might include events coming up at the location, or presentation sites 104 at the location to temporarily avoid due to overcrowding and congestion. The notification module 424 is also configured to send and receive notifications between individual wearable computing devices in the same group network. In this way, messages can be sent between users 108 in the same group 112.

The goal tracking module 426 is configured to compare the presentation plan to the augmented reality presentations actually experienced by the group 112, and make additional recommendations based on presentations in the presentation plan that have not yet been experienced. In some embodiments, the goal tracking module 426, through the notification module 424, periodically sends a goal tracking report to at least one of the wearable computing devices 110 in the group network. For example, a teacher might have a set of specific goals outlined for individual class members, and the notification module 424 can keep the teacher updated about the progress of the students through their respective goals.

The sensor management module 428 is configured to record all of the information received from the sensors associated with the wearable computing devices 110 and the presentation system 106. Those sensors can include cameras, microphones, biometric sensors, motion sensors, location determination sensors, and other sensors. The sensor management module 428 receives all of the sensor data and determines, through a user context determination module 430 various reactions that the user 108 is experiencing. The user context determination module 430 determines context data about the user. Context data can be any type of data that describes the environment and surroundings of the user 108. For example, context data can include the location of the user, the direction of travel of the user, whether the user is laughing or in a different emotional state, and other information about the user. The user context determination module 430 receives the context data from the sensors 234, 338 and determines information about the user 108. In some embodiments, the user context determination module 430 determines whether the user 108 is having an adverse or favorable reaction to the augmented reality presentation being presented. If the user 108 is reacting adversely, the user context determination module 430 might adjust the augmented reality presentation being presented to better suit the tastes of the user 108.

The post-visit presentation module 432 is configured to create a post-visit presentation to show to the group 112 after the visit to the location, e.g., the museum, has concluded. An augmented reality presentation sensor capture module 434 records all of the augmented reality presentations presented to the group 112. The augmented reality presentation sensor capture module 434 also records all of the video captured by one or more cameras associated with the wearable computing devices 110 or the presentation systems 106, and module 434 records all of the context data received by the shared presentation server 102. The post-visit presentation module 432 selects presentation elements to become part of the post-visit presentation based on the context data received. For example, the post-visit presentation module 432 can decide to include a particular portion of the augmented reality presentation to include in the post-visit presentation based on laughter detected by the sensors 234, 338. In some embodiments, the post-visit presentation comprises a collection of video captured by one or more cameras associated with either the wearable computing devices 110 or the presentation systems 106, for example, a video montage of the visit. The specific footage can be selected for inclusion in the post-visit presentation based on the reactions of the users 108 to the augmented reality presentation, as measured by the context data. In other embodiments, the post-visit presentation is an augmented reality presentation presented using the wearable computing devices 110 after the visit to the location has concluded.

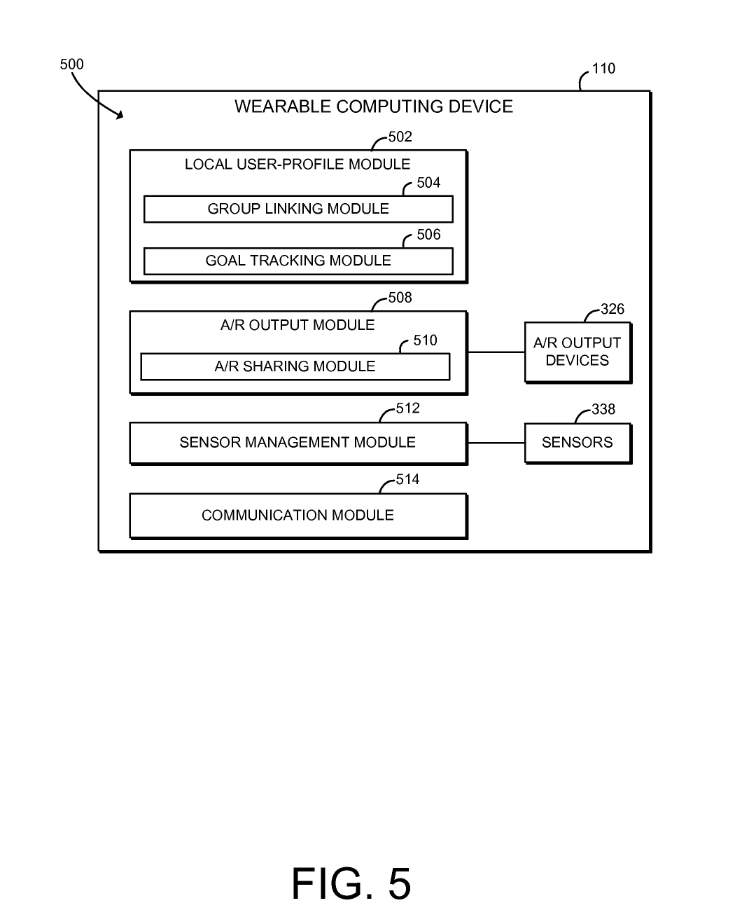

Referring now to FIG. 5, in the illustrative embodiment, the wearable computing device 110 establishes an environment 500 during operation. The illustrative embodiment 500 includes a local user profile module 502, an augmented reality output module 508, a sensor management module 512, and a communication module 514. In use, the wearable computing device 110 is configured to output an augmented reality presentation to the user 108 of the wearable computing device 110, sense context data regarding the user 108, and communicate with the shared presentation server 102. The various modules of the environment 500 may be embodied as hardware, firmware, software, or a combination thereof. For example the various modules, logic, and other components of the environment 500 may form a portion of, or otherwise be established by, the processor 320 or other hardware components of the computing device 110.

The local user profile module 502 is configured to link an individual wearable computing device 110 to an individual user profile. Before engaging in the augmented reality presentation, the user 108 creates a user-profile from which a presentation plan is generated. In the illustrative embodiment, the user profile includes information, such as, the group 112 the user 108 is a part of and other information about the user including, for example, preferences of augmented reality presentations that the user 108 would like to experience. The local user profile module 502 includes a group linking module 504 and a goal tracking module 506. The group linking module 504 is configured to link all of the wearable computing devices associated with a particular group 112 into a group network. Once a group network is established, the shared presentation server 102 can coordinate a shared augmented reality presentation between all of the wearable computing devices 110 that are part of the group network. The goal tracking module 506 tracks the completion of both individual user goals and group goals. The goal tracking module 506 can also provide notifications to the user 108 about augmented reality presentations that the user 108 might be interested in.

The augmented reality output module 508 is configured to output the augmented reality presentation received from the group presentation server to the user 108. After the shared presentation server 102 generates individual presentation data for each of the wearable computing devices 110, the shared presentation server 102 transmits that information to the corresponding wearable computing device 110. The augmented reality output module 508 uses the individualized presentation data to create the user-specific augmented reality presentation. To accomplish this, the augmented reality output module 508 interacts with the augmented reality output devices 326 that are part of the wearable computing device 110. For example, the augmented reality output module 508 can interact with display 330 to show an augmented reality presentation element that consists of King Tut standing in the room, or module 508 can interact with speakers 332 to cause the user 108 to hear a particular sound at a particular time.

The augmented reality output module 508 also includes an augmented reality sharing module 510, which is configured to allow members of the group 112 to share different perspectives with other members of the group 112, through the wearable computing device 110. In some embodiments, the augmented reality sharing module 510 allows the user 108 to share what the user 108 is seeing, hearing, smelling, or feeling with another member of the group 112, via the other member's wearable computing device 110. For example, a user 108 could share what the user 108 is seeing with another member of the group 112 by outputting the user's 108 camera 340 output to the display 330 of the other member's wearable computing device 110. In some embodiments, the augmented reality sharing module 510 shares the information between individual wearable computing devices 110 that are part of the group network through the shared presentation server 102; in other embodiments, the augmented reality sharing module 510 shares the information directly with other wearable computing devices 110 in the same group network.

The augmented reality sharing module 510 allows the group 112 to experience a group augmented reality experience even if the group 112 is not all located at the same location. In practice, members of the group 112 at times will be allowed to roam the location, e.g., a museum, and visit presentation sites 104 independently. During a free roam period, the users 108 in group 112 will likely be located at multiple presentation sites 104, for example, some members of the group might be visiting the ancient Egypt exhibit, while other members of the group are visiting the ancient Rome exhibit. During the free roam period, the wearable computing devices 110 are configured to allow various types of communication between the wearable computing devices 110 in the group network. For example, the augmented reality sharing module 510 can allow users 108 to communicate with each using their respective wearable computing devices 110. In another example, a wearable computing device 110 can be configured to share its location with other wearable computing devices 110 in the group network. The system 100 can track where all of the members of the group have been and make suggestions to other members of the group 112 based on the information. As discussed above, in another example, members of the group 112 can share perspectives with other wearable computing devices 110. In some embodiments, augmented reality perspectives are automatically shared with other wearable computing devices 110 in the group network, if the context data indicates that a certain behavior threshold has been met, for example, certain members of the group are laughing. In some embodiments, the augmented reality sharing module 510 cooperates with the goal tracking module 506 to share a user's 108 goal progress with another member of the group 112. For example, a teacher could specify that certain students visit certain presentation sites 104. The teacher could include this information in the user profiles of the individual students. Through the augmented reality sharing module 510 the teacher can receive notifications about a student's progress through the planned presentation sites 104. For example, the teacher would receive a notification when a student was not following an individual presentation plan.

The sensor management module 512 is configured to manage the sensors that are integrated with the wearable computing device 110. The sensor management module 512 records all of the data collected by sensors 338, which includes context data, and transmits the context data to the shared presentation server 102 through the communication module 514.

The communication module 514 is configured to allow the wearable computing device 110 to communicate with the shared presentation server 102 and other wearable computing devices 110. The communication module 514 is configured to handle all of the different types of data that the wearable computing device 110 and corresponds to the communication subsystem 350. The communication module 514 may be configured to use any one or more communication technology (e.g., wired or wireless communications) and associated protocols (e.g., Ethernet, Bluetooth®, Wi-Fi®, WiMAX, etc.) to effect such communication.

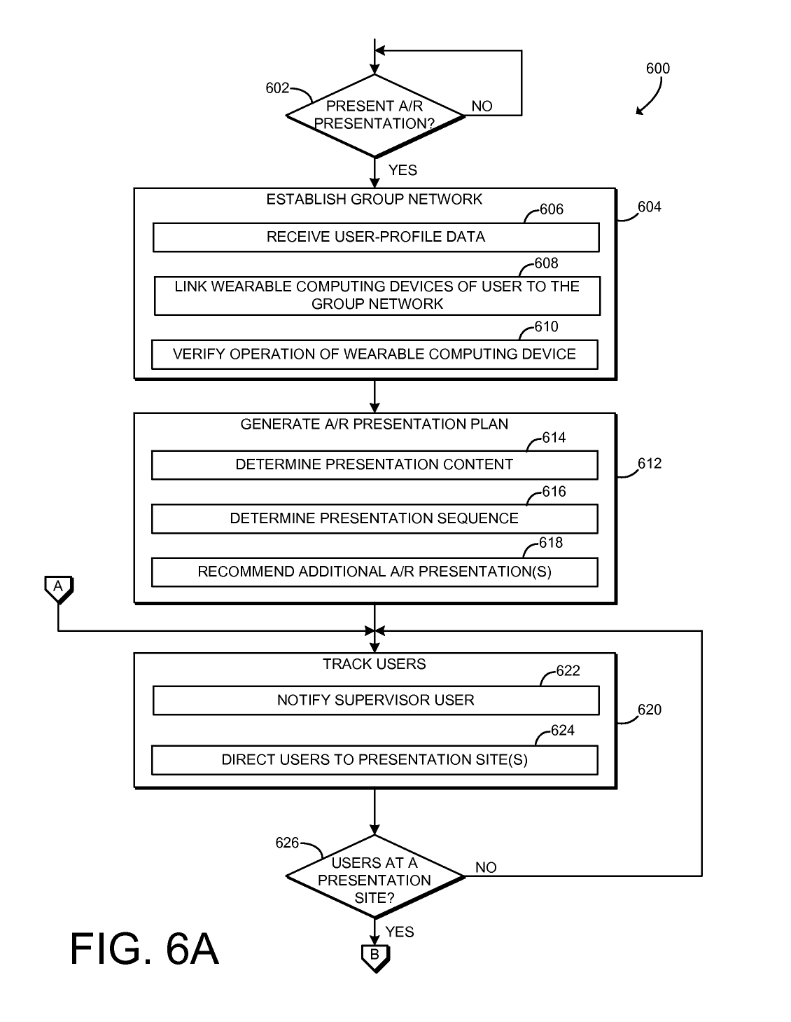

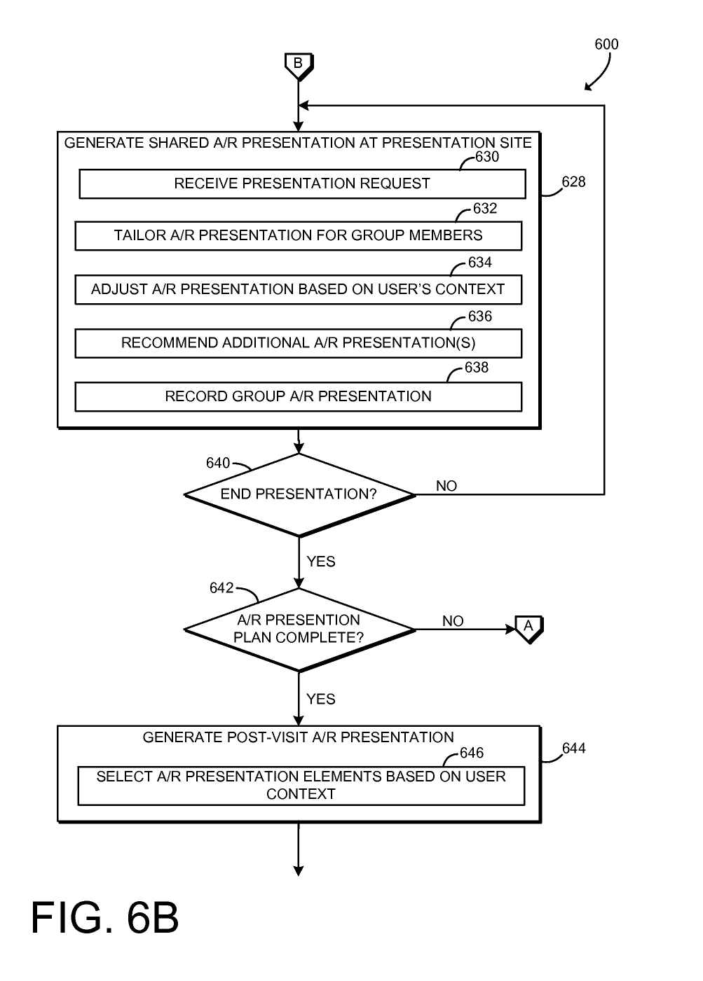

Referring now to FIG. 6A, in use, the shared presentation server 102 may execute a method 600 for presenting a shared augmented reality presentation. At block 602, the shared presentation server 102 waits to receive a group presentation request. In some embodiments, the group presentation request comes when a group profile is made and stored in the user profile database 406; in other embodiments, the group presentation request occurs when the group arrives at the location associated with the shared presentation server 102. For example, when a group 112 of users 108 come to a museum and want to participate in a shared augmented reality experience, the group 112 will request that they receive wearable computing devices 110 linked together as a group network. At block 604, the shared presentation server 102 establishes a group network by linking at least two wearable computing devices 110 together. Establishing a group network includes, at block 606, receiving user profile data. Receiving user profile data can include the user entering data to form a completely unique user profile, or it can include a user selecting from a pool of pre-defined generic user profiles. The user profiles are loaded onto the data storage of the wearable computing device 110. At block 608, the wearable computing devices 110 associated with the users 108 of the group 112 are linked to form a group network. The group network is a unique network of wearable computing devices 110 associated with a particular group 112. The group network allows the shared presentation server 102 to coordinate a shared augmented reality presentation with the wearable computing devices 110 in the group network, and allows the wearable computing devices 110 in the group network to communicate with each other. At block 610, the shared presentation server 102 verifies that the wearable computing devices 110 in the group network are working, ensuring that all users 108 can fully participate in the shared augmented reality presentations.

At block 612, the group presentation server generates an augmented reality presentation plan. The presentation plan is made by comparing the user profile data with a pool of available augmented reality presentations available at the various presentation sites 104. At block 614, the shared presentation server 102 determines the presentation content of the presentation plan by selecting various augmented reality presentations to show the group 112 based on the group user profile and the individual user profiles received by the shared presentation server 102. In some embodiments, the augmented reality presentations included in the presentation plan are rated according to a confidence score. The confidence score corresponds to how likely the shared presentation server 102 thinks the group 112 is interested in a particular augmented reality presentation, based on the user profiles. After rating all of the available augmented reality presentations, the shared presentation server 102 chooses the most relevant presentations to include in the group presentation plan. At block 616, the shared presentation server 102 determines a presentation sequence for showing the selected augmented reality presentations to the group 112. In some embodiments, the sequence of presentations is determined by the layout of the location, for example, the sequence is chosen to minimize the walking distance of the group. In other embodiments, the sequence of presentations is determined by specific goals outlined by the users 108 of the group 112. For example, if a class of students comes to a museum the teacher might have specific things that the teacher wants to show the class in a particular order. At block 618, the presentation plan includes a list of additional augmented reality presentations that the group 112 might be interested. In some embodiments, the list of additional augmented reality presentations is populated by determining which augmented reality presentations not included in the presentation plan have the highest confidence score.

At block 620, the shared presentation server 102 tracks the users 108 as they travel through the location. The tracking of the users 108 can include tracking to determine when the group 112 has arrived at a presentation site 104 in the presentation plan. The tracking of users 108 can also include tracking while users 108 are engaged in roaming freely around the location. In some embodiments, these two different scenarios require the shared presentation server 102 to perform different tracking tasks. For example, if the group 112 is following the presentation plan, and is not roaming freely, then, at block 622, the shared presentation server 102 will notify a supervisor user immediately if another user 108 in the group 112 separates from the group 112. However, if the group 112 is roaming the location, then the supervisor need not be notified immediately when a user 108 goes to another area of the location. Instead, the shared presentation server 102 will only passively notify the supervisor of other users 108 location, for example, only when a supervisor enters a group 112 location request. At block 624, the shared presentation server 102 directs users 108 to particular presentation sites that the particular users 108 might be interested in. For example, if the group 112 is following the presentation plan, then the shared presentation server 102 will direct the group 112 to the next augmented reality presentation on the presentation plan. In another example, if the users 108 of the group are roaming the location, the shared presentation server 102 can direct users 108 to a presentation site 104 that the user 108 might individually be interested in.

At block 626, the shared presentation server 102 determines if users 108 of the group 112 are present at a presentation site 104. In some embodiments, if the users 108 are at a presentation site 104 the shared presentation server 102 will immediately start the augmented reality presentation at that particular site 104. In other embodiments, the shared presentation server 102 might wait for one or more users to enter a presentation request before being an augmented reality presentation, for example, a user 108 sends a presentation request by entering a command, such as pushing a button. If the users 108 are not at a presentation site 104, then the shared presentation server 102 continues to the track the users 108, as discussed in block 620.

Referring now to FIG. 6B, the method 600 continues with block 630, in which the shared presentation server 102 generates a shared augmented reality presentation at a presentation site 104. The augmented reality presentation begins after the shared presentation server 102 receives a presentation request, at block 630. In some embodiments, the presentation request involves a user 108 providing an input, for example, the user 108 pushes a start button associated with the presentation site 104 or giving a command that the user's 108 wearable computing device can interpret (e.g., a voice command detected by microphone 342). In other embodiments, the presentation request is sent automatically to the shared presentation server 102 when a user 108 arrives at a presentation site.

Before beginning the augmented reality presentation, the shared presentation server 102, at block 632, consults the presentation plan to determine if the presentation plan requires the shared presentation server 102 to tailor the augmented reality presentation to meet specific needs of the group 112. For example, an augmented reality presentation might include a number of alternative elements that can be used in the shared augmented reality presentation. The use of alternative elements allows the shared presentation server 102 to tailor the presentation to meet the needs of the group 112. For example, an augmented reality presentation given to first graders at the ancient Egypt presentation site 104 will include different elements than an augmented reality presentation given to high school seniors. At block 634, the shared presentation server 102 receives context data from the sensors 234, 338, and adjusts the augmented reality presentation based on the context data received. For example, the context data might indicate that the group 112 is laughing and enjoying the presentation, so the shared presentation server 102 might show more of the augmented presentation than originally planned. At block 638, the shared presentation server 102 records the group augmented reality presentation for use in a post-visit presentation. The recording includes recoding all inputs received from the sensors 234, 238 associated with the presentation sites 104 and the wearable computing devices 110.

At block 640, the shared presentation server 102 determines if the augmented reality presentation currently being experienced has concluded. If the augmented reality presentation has not concluded then the shared presentation server 102 continues to perform the steps discussed in block 628. Otherwise, if the augmented reality presentation has concluded, at block 642, the shared presentation server 102 determines if the visit to the location has been completed. If the visit to the location has not been completed, then the shared presentation server 102 again tracks the users 108, as discussed in block 620, and waits to receive another presentation request.

If the visit is complete, at block 644, the shared presentation server 102 generates a post-visit augmented reality presentation of the group's 112 visit to the location. In some embodiments, the post-visit presentation comprises a video montage created using video captured by cameras 340 and cameras that are part of presentation systems 106 at presentation sites 104. At block 646, the shared presentation server 102 analyzes the context data received from the sensors 234, 338 and determines which presentation elements to include in the post-visit presentation based on the context data. For example, if the context data indicates that laughter occurred at a particular point during an augmented reality presentation, then the shared presentation server 102 would include video from the incident that incited the laugher in the post-visit presentation.

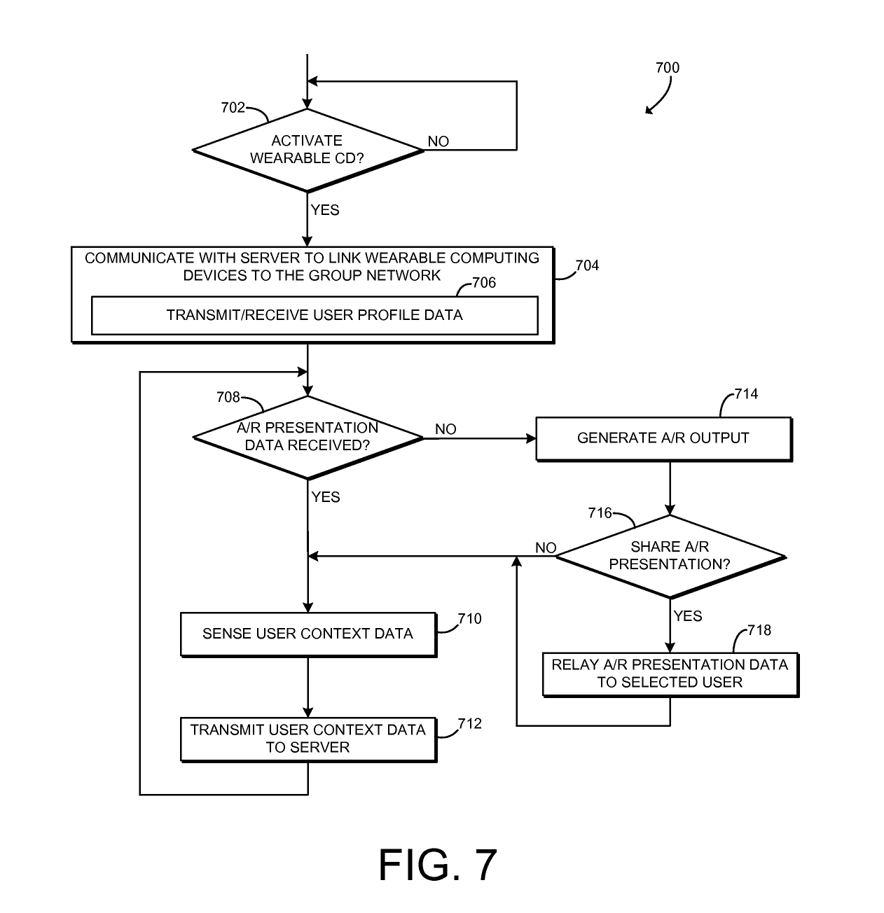

Referring now to FIG. 7, in use, the wearable computing device 110 may execute a method 700 for presenting a shared augmented reality presentation. At block 702, the wearable computing device 110 is activated. In some embodiments, the wearable computing device 110 is activated after receiving an activation signal from the group presentation server, the activation signal comprising a command that the wearable computing device 110 become part of a group network. At block 704, the wearable computing device 110 communicates with the shared presentation server 102 to join a group network established by the group presentation server. Along with the establishment of a group network the wearable computing device is linked to a particular user 108. At block 706, the wearable computing device 110 stores user profile data in its memory. In some embodiments, the user profile data is downloaded from the shared presentation server 102; in other embodiments, the user 108 creates the user profile using the wearable computing device 110.

At block 708, the wearable computing device 110 determines if augmented reality presentation data has been received from the shared presentation server 102. The augmented reality presentation data is individualized presentation data for the wearable computing device 110 that gives the user 108 of the wearable computing device 110 a unique perspective on a shared augmented reality presentation. In some embodiments, the presentation data is only transmitted to the wearable computing device 110 after a presentation request has been received and processed by the group presentation server.

At block 710, the wearable computing device 110 senses user context data with sensors 338. The context data that is sensed can include the location of the wearable computing device, the reaction of the user 108 of the wearable computing device 110 to the augmented reality presentation, or sounds made by the user, such as laughter or talking. For instance, sensors 338 can be used to detect physiological responses of the user 108, such as, a heart rate, a breathing rate, and sounds such as laughter. At block 712, after obtaining those measurements of context data, the wearable computing device 110 transmits the context data to the shared presentation server 102.

At block 714, the wearable computing device 110 generates an augmented reality output using the augmented reality output devices 326. Using a combination of displays, speakers, tactile actuators, and olfactory actuators, the wearable computing device 110 outputs the augmented reality presentation to the user 108. At block 716, the wearable computing device determines whether the user 108 wants to share the augmented reality presentation with another wearable computing device 110 in the group network. If the user 108 has not input a command to share the augmented reality presentation, then the wearable computing device 110 continues with the process of sensing context data and generating augmented reality outputs. If the user 108 wants to share the augmented reality presentation, then, at block 718, the wearable computing device 110 relays the augmented reality presentation data to the wearable computing device 110 of the selected user 108.

### EXAMPLES

Illustrative examples of the technologies disclosed herein are provided below. An embodiment of the technologies may include any one or more, and any combination of, the examples described below.

Example 1 includes a group presentation server for generating a group augmented reality experience, the group presentation server comprising a database having stored therein a pool of available augmented reality presentations; a group establishment module to establish a group network of wearable computing devices; an augmented reality presentation plan module to generate an augmented reality presentation plan based on a presentation request received from a user and the pool of available augmented reality presentations; and an augmented reality presentation module to generate a shared augmented reality presentation for the group network by the transmission of individual augmented reality presentation data to each wearable computing devices, wherein each augmented reality presentation data is based on the augmented reality presentation plan and customized for each wearable computing device.

Example 2 includes the subject matter of Example 1, and wherein group establishment module is to receive user-profile data that includes group information; and establish a group network of wearable computing devices based on the group information from the user-profile data associated with each wearable computing device.

Example 3 includes the subject matter of any of Examples 1 and 2, and wherein the group establishment module is to verify the operation of each of the wearable computing devices in the group network.

Example 4 includes the subject matter of any of Examples 1-3, and wherein the augmented reality presentation plan module is to determine presentation content to be included in the augmented reality presentation based on the presentation request and the augmented reality presentations.

Example 5 includes the subject matter of any of Examples 1-4, and wherein the augmented reality presentation plan module is to select an augmented reality presentation from the pool of augmented reality presentations based on the presentation request, and add the selected augmented reality presentation to the augmented reality presentation plan.

Example 6 includes the subject matter of any of Examples 1-5, and wherein the augmented reality presentation plan module is to determine a presentation sequence of each augmented reality presentation of the augmented reality presentation plan.

Example 7 includes the subject matter of any of Examples 1-6, and wherein the augmented reality presentation module is to receive a group-profile and individual user-profiles for each member of a group; and generate the augmented reality presentation plan based on the group-profile, the individual user-profiles, the presentation request, and the pool of available augmented reality presentations.

Example 8 includes the subject matter of any of Examples 1-7, and wherein the augmented reality presentation module is to generate an individual augmented reality presentation for each wearable computing device of the group network based on the shared augmented reality presentation; generate individual augmented reality presentation data for each of the individual augmented reality presentations; and transmit the individual augmented reality presentation data to each corresponding wearable computing device of the group network.

Example 9 includes the subject matter of any of Examples 1-8, and wherein the augmented reality presentation module is to receive from each wearable computing device, location data indicative of a location of a user of the corresponding wearable computing device within a presentation site at which the shared augmented reality presentation is generated; and generate an individual augmented reality presentation for each wearable computing device of the group network based on the location data associated with the corresponding wearable computing device and the shared augmented reality presentation.

Example 10 includes the subject matter of any of Examples 1-9, and wherein the augmented reality presentation module is to receive context data from each of the wearable computing devices in the group network; and adjust the shared augmented reality presentation based on the context data.

Example 11 includes the subject matter of any of Examples 1-10, and wherein the augmented reality presentation module is to transmit to the group network of wearable computing devices, recommendation of additional augmented reality presentations not currently included in the augmented reality presentation plan.

Example 12 includes the subject matter of any of Examples 1-11, and wherein the augmented reality presentation module is to record the shared augmented reality presentation.

Example 13 includes the subject matter of any of Examples 1-12, and wherein the augmented reality presentation module is to record the individual augmented reality presentation data.

Example 14 includes the subject matter of any of Examples 1-13, and wherein the augmented reality presentation module is to receive context data indicative of a context of a wearable computing device or a context of a user of the corresponding wearable computing device; and store the context data of each wearable computing device in association with the individual augmented reality presentation data transmitted to the corresponding wearable computing device.

Example 15 includes the subject matter of any of Examples 1-14, and wherein the augmented reality presentation module is to track the location of each wearable computing device of the group network.

Example 16 includes the subject matter of any of Examples 1-15, and wherein the augmented reality presentation module is to transmit a notification to at least one wearable computing device of the group network that identifies the location of at least one other wearable computing device of the group network.

Example 17 includes the subject matter of any of Examples 1-16, and wherein the augmented reality presentation module is to transmit to a wearable computing device of the group network, a recommendation of at least one additional augmented reality presentation not currently included in the augmented reality presentation plan.

Example 18 includes the subject matter of any of Examples 1-17, and further including a post-visit presentation module to generate a post-visit presentation based on the shared augmented reality presentation.

Example 19 includes the subject matter of any of Examples 1-18, and wherein the post-visit presentation module is to record the shared augmented reality presentation; receive, during the presentation of the shared augmented reality presentation, context data indicative of a context of a wearable computing device or a context of a user of the corresponding wearable computing device; and select presentation elements of the shared augmented reality presentation based on the context data to generate the post-visit presentation.

Example 20 includes the subject matter of any of Examples 1-19, and wherein the presentation elements include at least one of video or audio generated during the shared augmented reality presentation.

Example 21 includes a wearable computing device for generating an augmented reality experience, the wearable computing device comprising at least one augmented reality output device; a local user-profile module to communicate with a group presentation server to establish a group network with at least one additional wearable computing device; a communication module to receive augmented reality presentation data from the group presentation server, wherein the augmented reality presentation data is customized for the wearable computing device and defines a shared augmented reality presentation that is shared with the at least one additional wearable computing device; and an augmented reality output module to control the at least one augmented reality output device based on the augmented reality presentation data to generate an augmented reality presentation.

Example 22 includes the subject matter of Example 21, and wherein the communication module is to transmit, or receive, user-profile data related to the user of the wearable computing device.

Example 23 includes the subject matter of any of Examples 21 and 22, and further including one or more sensors of the wearable computing device; and a sensor management module to detect context data indicative of a reaction of the user of the wearable computing device to the augmented reality presentation, and transmit the context data to the group presentation server.

Example 24 includes the subject matter of any of Examples 21-23, and wherein the communication module is to relay to at least one additional wearable computing device, the augmented reality presentation data.

Example 25 a method of generating a group augmented reality experience, the method comprising establishing, by a group presentation server, a group network of wearable computing devices; generating, by the group presentation server, an augmented reality presentation plan based on a presentation request received from a user and a pool of available augmented reality presentations; and generating, by the group presentation server, a shared augmented reality presentation for the group network by transmitting individual augmented reality presentation data to each wearable computing devices, wherein each augmented reality presentation data is based on the augmented reality presentation plan and customized for each wearable computing device.

Example 26 includes the subject matter of Example 25, and wherein establishing a group network comprises receiving, by the group presentation server, user-profile data, and establishing, by the group presentation server, a group network of wearable computing devices based on a user-profile data.

Example 27 includes the subject matter of any of Examples 25 and 26, and wherein establishing a group network further comprises verifying, by the group presentation server, the operation of each of the wearable computing devices in the group network.

Example 28 includes the subject matter of any of Examples 25-27, and wherein generating the augmented reality presentation plan comprises determining, by the group presentation server, presentation content to be included in the an augmented reality presentation based on the presentation request and the augmented reality presentations.

Example 29 includes the subject matter of any of Examples 25-28, and wherein determining presentation content comprises selecting, by the group presentation server, an augmented reality presentation from the pool of augmented reality presentations based on the presentation request; and adding, by the group presentation server, the selected augmented reality presentation to the augmented reality presentation plan.

Example 30 includes the subject matter of any of Examples 25-29, and wherein generating the augmented reality presentation plan comprises determining, by the group presentation server, a presentation sequence of each augmented reality presentation of the augmented reality presentation plan.

Example 31 includes the subject matter of any of Examples 25-30, and wherein generating the augmented reality presentation plan comprises receiving, by the group presentation server, a group-profile and individual user-profiles for each member of a group; and generating the augmented reality presentation plan based on the group-profile, the individual user-profiles, the presentation request, and the pool of available augmented reality presentations.

Example 32 includes the subject matter of any of Examples 25-31, and wherein generating the shared augmented reality presentation for the group network comprises generating, by the group presentation server, an individual augmented reality presentation for each wearable computing device of the group network based on the shared augmented reality presentation, generating, by the group presentations server, individual augmented reality presentation data for each of the individual augmented reality presentations; and transmitting, by the group presentation server, the individual augmented reality presentation data to each corresponding wearable computing device of the group network.

Example 33 includes the subject matter of any of Examples 25-32, and wherein generating an individual augmented reality presentation comprises receiving, by the group presentation server and from each wearable computing device, location data indicative of a location of a user of the corresponding wearable computing device within a presentation site at which the shared augmented reality presentation is generated, and generating, by the group presentation server, an individual augmented reality presentation for each wearable computing device of the group network based on the location data associated with the corresponding wearable computing device and the shared augmented reality presentation.

Example 34 includes the subject matter of any of Examples 25-33, and wherein generating a shared augmented reality presentation comprises receiving, by the group presentation server, context data from each of the wearable computing devices in the group network, and adjusting, by the group presentation server, the shared augmented reality presentation based on the context data.

Example 35 includes the subject matter of any of Examples 25-34, and wherein generating a shared augmented reality presentation comprises transmitting, by the group presentation server and to the group network of wearable computing devices, recommendations of additional augmented reality presentations not currently included in the augmented reality presentation plan.

Example 36 includes the subject matter of any of Examples 25-35, and wherein generating a shared augmented reality presentation comprises recording, by the group presentation server, the shared augmented reality presentation.

Example 37 includes the subject matter of any of Examples 25-36, and wherein recording the shared augmented reality presentation comprises recording, by the group presentation server, the individual augmented reality presentation data.

Example 38 includes the subject matter of any of Examples 25-37, and wherein recording the shared augmented reality presentation comprises receiving, by the group presentation server, context data indicative of a context of the corresponding wearable computing device or a context of a user of the corresponding wearable computing device, and storing, by the group presentation server, the context data of each wearable computing device in association with the individual augmented reality presentation data transmitted to the corresponding wearable computing device.

Example 39 includes the subject matter of any of Examples 25-38, and further including tracking, by the group presentation server, the location of each wearable computing device of the group network.

Example 40 includes the subject matter of any of Examples 25-39, and wherein tracking the location of each wearable computing device comprises transmitting, by the group presentation server, a notification to at least one wearable computing device of the group network that identifies the location of at least one other wearable computing device of the group network.

Example 41 includes the subject matter of any of Examples 25-40, and wherein tracking the location of each of the wearable computing devices comprises transmitting, by the group presentation server and to a wearable computing device of the group network, a recommendation of at least one additional augmented reality presentation not currently included in the augmented reality presentation plan.

Example 42 includes the subject matter of any of Examples 25-41, and further including generating, by the group presentation server, a post-visit presentation based on the shared augmented reality presentation.

Example 43 includes the subject matter of any of Examples 25-42, and wherein generating the post-visit presentation comprises recording, by the group presentation server, the shared augmented reality presentation receiving, by the group presentation server, and during the presentation of the shared augmented reality presentation, context data indicative of a context of a wearable computing device or a context of a user of the corresponding wearable computing device; and selecting, by the group presentation server, presentation elements of the shared augmented reality presentation based on the context data to generate the post-visit presentation.

Example 44 includes the subject matter of any of Examples 25-43, and wherein the presentation elements include at least one of video or audio generated during the shared augmented reality presentation.

Example 45 includes a method of generating an augmented reality experience, the method comprising communicating, by a wearable computing device, with a group presentation server to establish a group network with at least one additional wearable computing device; receiving, by the wearable computing device, augmented reality presentation data from the group presentation server, wherein the augmented reality presentation data is customized for the wearable computing device and defines a shared augmented reality presentation that is shared with the at least one additional wearable computing device; and generating, by the wearable computing device, an augmented reality presentation using the augmented reality presentation data.

Example 46 includes the subject matter of Example 45, and wherein communicating with the group presentation server comprises transmitting or receiving user-profile data related to the user of the wearable computing device.

Example 47 includes the subject matter of any of Examples 45 and 46, and further including, sensing, by one or more sensors of the wearable computing device, context data indicative of a reaction of the user of the wearable computing device to the augmented reality presentation, and transmitting, by the wearable computing device, the context data to the group presentation server.

Example 48 includes the subject matter of any of Examples 45-47, and further including, relaying, by the wearable computing device, the augmented reality presentation data to the at least one additional wearable computing device.

Example 49 includes one or more machine readable storage media comprising a plurality of instructions stored thereon that in response to being executed result in a computing device performing the method of any of Examples 25-48.

Example 50 includes a group presentation server of generating a group augmented reality experience. The group presentation server includes means for establishing a group network of wearable computing devices; means for generating an augmented reality presentation plan based on a presentation request received from a user and a pool of available augmented reality presentations; and means for generating a shared augmented reality presentation for the group network by transmitting individual augmented reality presentation data to each wearable computing devices, wherein each augmented reality presentation data is based on the augmented reality presentation plan and customized for each wearable computing device.

Example 51 includes the subject matter of Example 50, and wherein the means for establishing a group network comprises means for receiving user-profile data, and means for establishing a group network of wearable computing devices based on a user-profile data.

Example 52 includes the subject matter of any of Examples 50 or 51, and wherein the means for establishing a group network further comprises means for verifying the operation of each of the wearable computing devices in the group network.

Example 53 includes the subject matter of any of Examples 50-52, and wherein the means for generating the augmented reality presentation plan comprises means for determining presentation content to be included in the an augmented reality presentation based on the presentation request and the augmented reality presentations.

Example 54 includes the subject matter of any of Examples 50-53, and wherein the means for determining presentation content comprises means for selecting an augmented reality presentation from the pool of augmented reality presentations based on the presentation request; and means for adding the selected augmented reality presentation to the augmented reality presentation plan.

Example 55 includes the subject matter of any of Examples 50-54, and wherein the means for generating the augmented reality presentation plan comprises means for determining a presentation sequence of each augmented reality presentation of the augmented reality presentation plan.

Example 56 includes the subject matter of any of Examples 50-55, and wherein the means for generating the augmented reality presentation plan comprises means for receiving a group-profile and individual user-profiles for each member of a group; and means for generating the augmented reality presentation plan based on the group-profile, the individual user-profiles, the presentation request, and the pool of available augmented reality presentations.

Example 57 includes the subject matter of any of Examples 50-56, and wherein the means for generating the shared augmented reality presentation for the group network comprises means for generating an individual augmented reality presentation for each wearable computing device of the group network based on the shared augmented reality presentation; means for generating individual augmented reality presentation data for each of the individual augmented reality presentations; and means for transmitting the individual augmented reality presentation data to each corresponding wearable computing device of the group network.

Example 58 includes the subject matter of any of Examples 50-57, and wherein the means for generating an individual augmented reality presentation comprises means for receiving location data indicative of a location of a user of the corresponding wearable computing device within a presentation site at which the shared augmented reality presentation is generated, and means for generating an individual augmented reality presentation for each wearable computing device of the group network based on the location data associated with the corresponding wearable computing device and the shared augmented reality presentation.

Example 59 includes the subject matter of any of Examples 50-58, and wherein the means for generating a shared augmented reality presentation comprises means for receiving context data from each of the wearable computing devices in the group network, and means for adjusting the shared augmented reality presentation based on the context data.

Example 60 includes the subject matter of any of Examples 50-59, and wherein the means for generating a shared augmented reality presentation comprises means for transmitting recommendations of additional augmented reality presentations not currently included in the augmented reality presentation plan.

Example 61 includes the subject matter of any of Examples 50-60, and wherein the means for generating a shared augmented reality presentation comprises means for recording the shared augmented reality presentation.

Example 62 includes the subject matter of any of Examples 50-61, and wherein the means for recording the shared augmented reality presentation comprises means for recording the individual augmented reality presentation data.

Example 63 includes the subject matter of any of Examples 50-62, and wherein the means for recording the shared augmented reality presentation comprises means for receiving context data indicative of a context of the corresponding wearable computing device or a context of a user of the corresponding wearable computing device, and means for storing the context data of each wearable computing device in association with the individual augmented reality presentation data transmitted to the corresponding wearable computing device.

Example 64 includes the subject matter of any of Examples 50-63, and further comprising means for tracking the location of each wearable computing device of the group network.

Example 65 includes the subject matter of any of Examples 50-64, and wherein the means for tracking the location of each wearable computing device comprises means for transmitting a notification to at least one wearable computing device of the group network that identifies the location of at least one other wearable computing device of the group network.

Example 66 includes the subject matter of any of Examples 50-65, and wherein the means for tracking the location of each of the wearable computing devices comprises means for transmitting a recommendation of at least one additional augmented reality presentation not currently included in the augmented reality presentation plan.

Example 67 includes the subject matter of any of Examples 50-66, and further comprising means for generating a post-visit presentation based on the shared augmented reality presentation.

Example 68 includes the subject matter of any of Examples 50-67, and wherein the means for generating the post-visit presentation comprises means for recording the shared augmented reality presentation; means for receiving and during the presentation of the shared augmented reality presentation, context data indicative of a context of a wearable computing device or a context of a user of the corresponding wearable computing device; and means for selecting presentation elements of the shared augmented reality presentation based on the context data to generate the post-visit presentation.

Example 69 includes the subject matter of any of Examples 50-68, and wherein the presentation elements include at least one of video or audio generated during the shared augmented reality presentation.

Example 70 includes a wearable computing device for generating an augmented reality experience. The wearable computing device includes means for communicating with a group presentation server to establish a group network with at least one additional wearable computing device; means for receiving augmented reality presentation data from the group presentation server, wherein the augmented reality presentation data is customized for the wearable computing device and defines a shared augmented reality presentation that is shared with the at least one additional wearable computing device; and means for generating an augmented reality presentation using the augmented reality presentation data.

Example 71 includes the subject matter of Example 70, and wherein the means for communicating with the group presentation server comprises means for transmitting or receiving user-profile data related to the user of the wearable computing device.

Example 72 includes the subject matter of any of Examples 70 or 71, and further comprises means for sensing context data indicative of a reaction of the user of the wearable computing device to the augmented reality presentation, and means for transmitting the context data to the group presentation server.

Example 73 includes the subject matter of any of Examples 70-72, and further comprising means for relaying the augmented reality presentation data to the at least one additional wearable computing device.

Example 74 includes an augmented reality system for generating a shared augmented reality experience. The augmented reality system includes a shared presentation server to generate a shared augmented reality presentation for a group network of wearable computing devices by the transmission of individual augmented reality presentation data to each wearable computing devices, wherein each augmented reality presentation data is based on the shared augmented reality presentation and customized for each wearable computing device.

1. A group presentation server for generating a group augmented reality experience, the group presentation server comprising:
a database having stored therein a pool of available augmented reality presentations;
a group establishment module to establish a group network of wearable computing devices;
an augmented reality presentation plan module to generate an augmented reality presentation plan based on a presentation request received from a user and the pool of available augmented reality presentations; and
an augmented reality presentation module to generate a shared augmented reality presentation for the group network by the transmission of individual augmented reality presentation data to each wearable computing devices, wherein each augmented reality presentation data is based on the augmented reality presentation plan and customized for each wearable computing device.

2. The group presentation server of claim 1, wherein group establishment module is to:
receive user-profile data that includes group information; and
establish a group network of wearable computing devices based on the group information from the user-profile data associated with each wearable computing device.

3. The group presentation server of claim 1, wherein the augmented reality presentation module is to:
receive a group-profile and individual user-profiles for each member of a group; and
generate the augmented reality presentation plan based on the group-profile, the individual user-profiles, the presentation request, and the pool of available augmented reality presentations.

4. The group presentation server of claim 1, wherein the augmented reality presentation module is to:
generate an individual augmented reality presentation for each wearable computing device of the group network based on the shared augmented reality presentation;
generate individual augmented reality presentation data for each of the individual augmented reality presentations; and
transmit the individual augmented reality presentation data to each corresponding wearable computing device of the group network.

5. The group presentation server of claim 4, wherein the augmented reality presentation module is to:
receive from each wearable computing device, location data indicative of a location of a user of the corresponding wearable computing device within a presentation site at which the shared augmented reality presentation is generated; and
generate an individual augmented reality presentation for each wearable computing device of the group network based on the location data associated with the corresponding wearable computing device and the shared augmented reality presentation.

6. The group presentation server of claim 1, wherein the augmented reality presentation module is to:
receive context data from each of the wearable computing devices in the group network; and
adjust the shared augmented reality presentation based on the context data.

7. The group presentation server of claim 1, wherein the augmented reality presentation module is to record the shared augmented reality presentation.

8. The group presentation server of claim 1, wherein the augmented reality presentation module is to track the location of each wearable computing device of the group network.

9. The group presentation server of claim 8, wherein the augmented reality presentation module is to transmit a notification to at least one wearable computing device of the group network that identifies the location of at least one other wearable computing device of the group network.

10. The group presentation server of claim 1, further comprising a post-visit presentation module to generate a post-visit presentation based on the shared augmented reality presentation.

11. A method of generating a group augmented reality experience, the method comprising:
establishing, by a group presentation server, a group network of wearable computing devices;
generating, by the group presentation server, an augmented reality presentation plan based on a presentation request received from a user and a pool of available augmented reality presentations; and
generating, by the group presentation server, a shared augmented reality presentation for the group network by transmitting individual augmented reality presentation data to each wearable computing devices, wherein each augmented reality presentation data is based on the augmented reality presentation plan and customized for each wearable computing device.

12. The method of claim 11, wherein generating the shared augmented reality presentation for the group network comprises:
generating, by the group presentation server, an individual augmented reality presentation for each wearable computing device of the group network based on the shared augmented reality presentation,
generating, by the group presentations server, individual augmented reality presentation data for each of the individual augmented reality presentations; and
transmitting, by the group presentation server, the individual augmented reality presentation data to each corresponding wearable computing device of the group network.

13. The method of claim 12, wherein generating an individual augmented reality presentation comprises:
receiving, by the group presentation server and from each wearable computing device, location data indicative of a location of a user of the corresponding wearable computing device within a presentation site at which the shared augmented reality presentation is generated, and
generating, by the group presentation server, an individual augmented reality presentation for each wearable computing device of the group network based on the location data associated with the corresponding wearable computing device and the shared augmented reality presentation.

14. One or more machine readable storage media comprising a plurality of instructions stored thereon that, in response to execution, cause a server computing device to:
establish, by a group presentation server, a group network of wearable computing devices;
generate, by the group presentation server, an augmented reality presentation plan based on a presentation request received from a user and a pool of available augmented reality presentations; and
generate, by the group presentation server, a shared augmented reality presentation for the group network by transmitting individual augmented reality presentation data to each wearable computing devices, wherein each augmented reality presentation data is based on the augmented reality presentation plan and customized for each wearable computing device.

15. The one or more machine readable storage media of claim 14, wherein to establish a group network comprises:
to receive, by the group presentation server, user-profile data, and
to establish, by the group presentation server, a group network of wearable computing devices based on a user-profile data.

16. The one or more machine readable storage media of claim 14, wherein to generate the augmented reality presentation plan comprises:
to receive, by the group presentation server, a group-profile and individual user-profiles for each member of a group; and
to generate the augmented reality presentation plan based on the group-profile, the individual user-profiles, the presentation request, and the pool of available augmented reality presentations.

17. The one or more machine readable storage media of claim 14, wherein to generate the shared augmented reality presentation for the group network comprises:
to generate, by the group presentation server, an individual augmented reality presentation for each wearable computing device of the group network based on the shared augmented reality presentation,
to generate, by the group presentations server, individual augmented reality presentation data for each of the individual augmented reality presentations; and
to transmit, by the group presentation server, the individual augmented reality presentation data to each corresponding wearable computing device of the group network.

18. The one or more machine readable storage media of claim 17, wherein to generate an individual augmented reality presentation comprises:
to receive, by the group presentation server and from each wearable computing device, location data indicative of a location of a user of the corresponding wearable computing device within a presentation site at which the shared augmented reality presentation is generated, and
to generate, by the group presentation server, an individual augmented reality presentation for each wearable computing device of the group network based on the location data associated with the corresponding wearable computing device and the shared augmented reality presentation.

19. The one or more machine readable storage media of claim 14, wherein to generate a shared augmented reality presentation comprises:
to receive, by the group presentation server, context data from each of the wearable computing devices in the group network, and
to adjust, by the group presentation server, the shared augmented reality presentation based on the context data.

20. The one or more machine readable storage media of claim 14, wherein to generate a shared augmented reality presentation comprises to record, by the group presentation server, the shared augmented reality presentation.

21. The one or more machine readable storage media of claim 14, further comprising to track, by the group presentation server, the location of each wearable computing device of the group network.

22. The one or more machine readable storage media of claim 21, wherein to track the location of each wearable computing device comprises to transmit, by the group presentation server, a notification to at least one wearable computing device of the group network that identifies the location of at least one other wearable computing device of the group network.

23. The one or more machine readable storage media of claim 14, further comprising to generate, by the group presentation server, a post-visit presentation based on the shared augmented reality presentation.

24. A wearable computing device for generating an augmented reality experience, the wearable computing device comprising:
at least one augmented reality output device;
a local user-profile module to communicate with a group presentation server to establish a group network with at least one additional wearable computing device;
a communication module to receive augmented reality presentation data from the group presentation server, wherein the augmented reality presentation data is customized for the wearable computing device and defines a shared augmented reality presentation that is shared with the at least one additional wearable computing device; and
an augmented reality output module to control the at least one augmented reality output device based on the augmented reality presentation data to generate an augmented reality presentation.

25. The wearable computing device of claim 24, further comprising:
one or more sensors of the wearable computing device; and
a sensor management module to detect context data indicative of a reaction of the user of the wearable computing device to the augmented reality presentation, and transmit the context data to the group presentation server.

26. An augmented reality system for generating a shared augmented reality experience, the augmented reality system comprising:
a shared presentation server to generate a shared augmented reality presentation for a group network of wearable computing devices by the transmission of individual augmented reality presentation data to each wearable computing devices, wherein each augmented reality presentation data is based on the shared augmented reality presentation and customized for each wearable computing device.
